(19) United States
(12) Patent Application Publication
(10) Pub. No.: US 2012/0238235 A1
(43) Pub. Date: Sep. 20, 2012

(54) Within-A-Radius Calling System and Service Method Thereof

(76) Inventor: Jae Hee Lee, Seoul (KR)

(21) Appl. No.: 13/281,392

(22) Filed: Oct. 25, 2011

(30) Foreign Application Priority Data
Mar. 18, 2011 (KR) 10-2011-0024174

(51) Int. Cl. H04W 4/16; H04W 4/22

(52) U.S. Cl. 455/404.2; 455/416

(57) ABSTRACT

The present invention discloses a within-a-radius calling system and a service method thereof, which can request a call from a member positioned within a certain radius. The within-a-radius calling system comprises: an application transmission unit; a member join/authentication unit; a storage unit; a radius information receiving unit; a position information receiving unit; a member search unit; and a within-a-radius calling unit.

### BACKGROUND OF THE INVENTION

1. Field of the Invention

The present invention relates to a within-a-radius calling system and a service method thereof, which can request a call using a mobile terminal.

2. Background of the Related Art

A terminal can be configured so as to perform a variety of functions. Examples of the variety of functions include a function of performing data and voice communications, a function of photographing pictures or moving images using a camera, a function of storing voices, a function of playing back music files through a speaker system, a function of displaying images or videos, and the like. The terminal may be either a mobile type or a fixed type depending on mobility. Particularly, mobile terminals are diversely developed recently considering mobility of users.

The mobile terminal includes an additional function for executing a game, and some other mobile terminals are implemented in a multimedia device. Furthermore, latest mobile terminals may receive broadcasting or multicasting signals so that users may watch videos or television programs.

In addition, the mobile terminal is provided with a short-range wireless communication means such as Bluetooth and provides a chatting service function which allows chatting with other terminals capable of performing short-range wireless communications while exchanging data or character messages with the terminals.

### SUMMARY OF THE INVENTION

Therefore, the present invention has been made in view of the above problems, and it is an object of the present invention to provide a within-a-radius calling system and a service method thereof, which can request a call from a member positioned within a certain radius.

To accomplish the above object, according to an embodiment of the present invention, there is provided a within-a-radius calling system including: an application transmission unit for transmitting information on an application so that the application can be installed in a plurality of mobile terminals including a transmitter mobile terminal and a receiver mobile terminal; a member join/authentication unit for joining a user of the mobile terminal installed with the application as a member and authenticating membership of the user; a storage unit for storing membership information of the user joined as a member; a radius information receiving unit for receiving information on a call radius of the transmitter mobile terminal, if the call radius information is set by a user of the transmitter mobile terminal; a position information receiving unit for receiving position information of the mobile terminal of the user joined as a member; a member search unit for determining whether or not a receiver mobile terminal used by another member is positioned within a call radius of the transmitter mobile terminal based on the call radius information; and a within-a-radius calling unit for transmitting a call signal to the receiver mobile terminal positioned within the call radius, if the user of the transmitter mobile terminal requests a call.

The within-a-radius calling unit may transmit the call signal to all mobile terminals positioned within the call radius, mobile terminals registered as a friend among the mobile terminals positioned within the call radius, or mobile terminals specified among the mobile terminals positioned within the call radius.

The application may display an interface screen capable of processing the call request on the mobile terminal, and the interface screen may be provided so as to handle a field related to an emergency call request and a field related to a general call request.

If the user of the transmitter mobile terminal clicks the field related to the emergency call request by handling the interface screen, the within-a-radius calling unit may transmit a signal containing a predetermined message and position information of the transmitter mobile terminal to the receiver mobile terminals positioned within the call radius.

If the user of the transmitter mobile terminal clicks the field related to the general call request by handling the interface screen, the within-a-radius calling unit may transmit a signal containing a message created by the user of the transmitter mobile terminal and position information of the transmitter mobile terminal to the receiver mobile terminals positioned within the call radius.

The within-a-radius calling unit may transmit a signal containing a message and position information of the transmitter mobile terminal when the within-a-radius calling unit transmits the call signal to the receiver mobile terminals, and the position information of the transmitter mobile terminal may be updated and transmitted in real-time.

The call radius information received by the radius information receiving unit may be updated by the user of the transmitter mobile terminal.

In addition, according to an embodiment of the present invention, there is provided a within-a-radius calling service method for providing a calling service in an environment of connecting a plurality of mobile terminals for providing the calling service and a within-a-radius calling system for relaying a call to enable the calling service among the mobile terminals, the method comprising the steps of: receiving and installing an application, by the plurality of mobile terminals; performing a process of joining users of the plurality of mobile terminals as a member and authenticating membership of the users; receiving information on call radiuses set by the users of the plurality of mobile terminals, by the within-a-radius calling system; confirming whether or not a second mobile terminal used by another member is positioned within a call radius of a first mobile terminal, if a user of the first mobile terminal among the plurality of mobile terminals executes the application in the within-a-radius calling system; and requesting a call from the user of the second mobile terminal positioned within the call radius of the first mobile terminal according to a call request of the user of the first mobile terminal in the within-a-radius calling system.

In the step of requesting a call from the user of the second mobile terminal positioned within the call radius of the first mobile terminal according to a call request of the user of the first mobile terminal in the within-a-radius calling system, the call signal may be transmitted to all mobile terminals positioned within the call radius, mobile terminals registered as a friend among the mobile terminals positioned within the call radius, or mobile terminals specified among the mobile terminals positioned within the call radius.

The within-a-radius calling service method may further comprise the step of displaying an interface screen capable of processing the call request on the mobile terminal according to handling of the application, wherein the interface screen is provided so as to handle a field related to an emergency call request and a field related to a general call request.

In the step of requesting a call from the user of the second mobile terminal positioned within the call radius of the first mobile terminal according to a call request of the user of the first mobile terminal in the within-a-radius calling system, if the user of the first mobile terminal clicks the field related to the emergency call request by handling the interface screen, a signal containing a predetermined message and position information of the first mobile terminal may be transmitted to the second mobile terminal positioned within the call radius.

In the step of requesting a call from the user of the second mobile terminal positioned within the call radius of the first mobile terminal according to a call request of the user of the first mobile terminal in the within-a-radius calling system, if the user of the first mobile terminal clicks the field related to the general call request by handling the interface screen, a signal containing a message created by the user of the first mobile terminal and position information of the first mobile terminal may be transmitted to the second mobile terminal positioned within the call radius.

In the step of requesting a call from the user of the second mobile terminal positioned within the call radius of the first mobile terminal according to a call request of the user of the first mobile terminal in the within-a-radius calling system, the call may be requested by transmitting a message and position information of the first mobile terminal to the user of the second mobile terminal in the within-a radius calling system.

The position information of the first mobile terminal transmitted in the within-a radius calling system may be updated and transmitted to the second mobile terminal in real-time.

### BRIEF DESCRIPTION OF THE DRAWINGS

FIG. 1 is a block diagram showing the configuration of a mobile terminal used for operating a within-a-radius calling system according to one aspect of the present invention.

FIG. 2 is a view illustrating a service setting method for data communication of a mobile terminal used for operating a within-a-radius calling system according to one aspect of the present invention.

FIG. 3 is a block diagram showing the configuration of a within-a-radius calling system according to an embodiment of the present invention.

FIG. 4 is a flowchart illustrating the procedure of joining a member and setting a function of a within-a-radius calling system according to an embodiment of the present invention.

FIG. 5 is a flowchart illustrating the control flow of a within-a-radius calling system according to an embodiment of the present invention.

FIG. 6 is a flowchart illustrating the control flow of a within-a-radius calling system according to an embodiment of the present invention.

### DETAILED DESCRIPTION OF THE PREFERRED EMBODIMENT

The present invention will be hereafter described in detail with reference to the accompanying drawings.

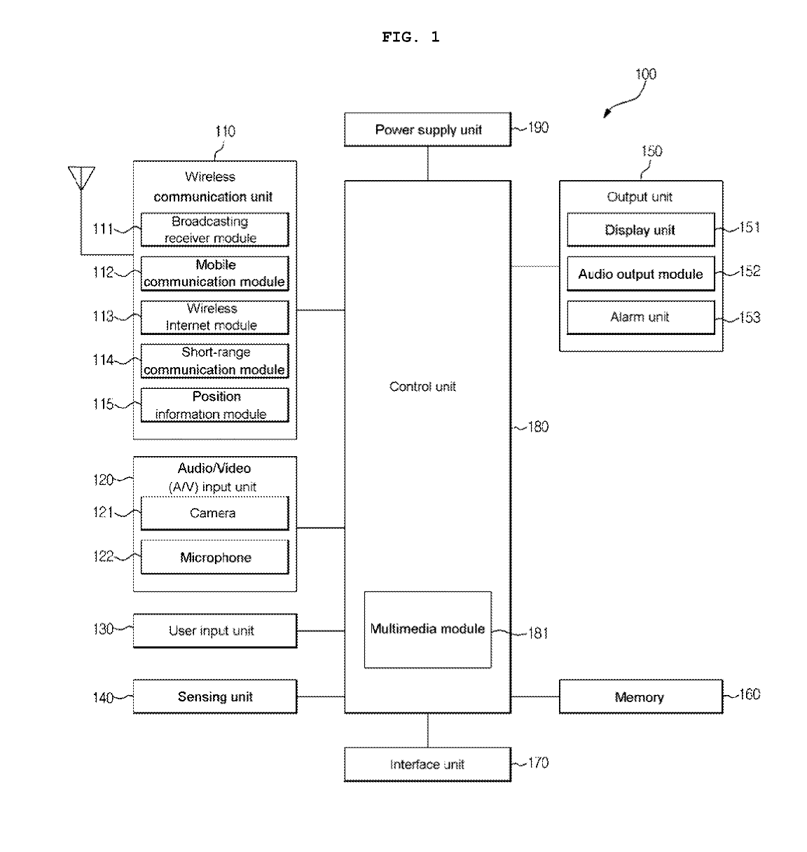

FIG. 1 is a block diagram showing the configuration of a mobile terminal used for operating a within-a-radius calling system according to one aspect of the present invention.

The mobile terminal 100 can be implemented in a variety of forms. The mobile terminal may include a cellular phone, a smart phone, a notebook computer, a digital broadcasting terminal, a Personal Digital Assistant (PDA), a Portable Multimedia Player PMP), a navigator, and the like.

The mobile terminal 100 may include a wireless communication unit 110, an Audio/Video (A/V) input unit 120, a user input unit 130, a sensing unit 140, an output unit 150, a memory 160, an interface unit 170, a control unit 180, and a power supply unit 190. FIG. 1 shows a mobile terminal having a variety of constitutional components. However, all of the constitutional components shown in the figure are not a prerequisite constitutional component. The mobile terminal can be implemented using constitutional components more than or less than the constitutional components shown in the figure. Hereinafter, the constitutional components will be described in detail.

The wireless communication unit 110 may include one or more constitutional components allowing wireless communication between the mobile terminal 100 and a wireless communication system or between the mobile terminal 100 and a network in which the mobile terminal 100 is positioned. For example, the wireless communication unit 110 may include a broadcasting receiver module 111, a mobile communication module 112, a wireless Internet module 113, a short-range communication module 114, a position information module 115, and the like.

The broadcasting receiver module 111 receives broadcasting signals and/or broadcasting-related information from an external broadcasting management server through a broadcasting channel. The broadcasting channel may include a satellite channel and a terrestrial wave channel. The broadcasting management server described above may be a server which generates and transmits the broadcasting signals or the broadcasting-related information, or a server which receives and transmits previously generated broadcasting signals or broadcasting-related information to a terminal. The broadcasting-related information may be a broadcasting channel, a broadcasting program, or information related to a broadcasting service provider. The broadcasting signal may be a TV broadcasting signal, a radio broadcasting signal, or a data broadcasting signal.

The broadcasting signal or the broadcasting-related information received through the broadcasting receiver module 111 can be stored in the memory 160.

The mobile communication module 112 transmits and receives radio signals to and from at least one of a base station, an external terminal, and a server in a mobile communication network. Here, the radio signal may include various types of data according to transmission and reception of a voice call signal, a video communication call signal, or a character/multimedia message.

The wireless Internet module 113 is a module for wireless Internet connection. The wireless Internet module 113 can be an internal or external type.

The short-range communication module 114 is a module for short-range communication. A short-range communication technique may include Bluetooth communication, Radio Frequency Identification (RFID) communication, Infrared Data Association (IrDA) communication, Ultra Wideband (UWB) communication, and Zigbee communication.

The position information module 115 is a module for confirming or obtaining a position of the mobile terminal 100. A Global Position System (GPS) module is an example of the position information module 115. The GPS module receives position information from a plurality of satellites. The position information may include coordinate information expressed in latitude and longitude. For example, the GPS module measures accurate time and distance from three or more satellites and may accurately calculate current position from three different distances using trigonometry. A method of obtaining information on distance and time from the three satellites and correcting errors using one satellite can be used. Particularly, the GPS module may obtain even a correct time together with three-dimensional speed information, as well as latitude, longitude, and height.

The A/V input unit 120 is for inputting audio or video signals and may include a camera 121 and a microphone unit 122. The camera 121 may process video frames such as still images or video images obtained by an image sensor, in a video communication mode or a photographing mode. The processed video frames can be displayed on a display unit 151.

The video frames processed by the camera 121 can be stored in the memory 160 or transmitted outside through the wireless communication unit 110. Two or more cameras 121 can be provided.

The microphone unit 122 receives audio signals from outside through a microphone and processes the audio signals into electrical voice data in a communication mode, a recording mode, or a voice recognition mode. The processed voice data can be converted into a transmittable form and transmitted to a mobile communication base station through the mobile communication module 112 in the communication mode. A variety of noise canceling algorithms can be implemented in the microphone unit 122 in order to eliminate noises generated in the process of receiving the audio signals from outside.

The user input unit 130 generates input data for controlling operation of the mobile terminal by a user. The user input unit 130 may be configured with a keypad, a dome switch, a touchpad, a jog wheel, a jog switch, and the like. Particularly, if the touchpad constructs an inter-layer structure together with the display unit 151 described below, it can be referred to as a touch screen.

The sensing unit 140 senses current state of the mobile terminal 100, such as an open and close state of the mobile terminal 100, a position of the mobile terminal 100, whether or not a user contacts the mobile terminal 100, an azimuth of the mobile terminal 100, and speed-up/speed-down of the mobile terminal 100, and the like, and generates a sensing signal for controlling operation of the mobile terminal 100. For example, if the mobile terminal 100 is a type of a slide phone, opening or closing of the slide phone can be sensed. In addition, the sensing unit 140 takes charge of a sensing function related to whether or not the power supplying unit 190 supplies power, whether or not an external device of the interface unit 170 is defective, and the like.

The interface unit 170 functions as an interface to all external devices connected to the mobile terminal 100. For example, the interface unit 170 may include a wired/wireless headset port, an external recharger port, a wired/wireless data port, a memory card port, a port for connecting an apparatus provided with an identification module, an audio Input/Output (I/O) port, a video Input/Output (I/O) port, an earphone port, and the like.

Here, the identification module is a chip for storing various kinds of information for authenticating authority for using the mobile terminal 100, which may include a user identity module, a subscriber identity module, a general-purpose user identity module, and the like. An apparatus provided with the identification module can be manufactured in the form of a smart card.

The output unit 150 is for outputting an audio signal, a video signal, or an alarm signal, which may include the display unit 151, an audio output module 152, an alarm unit 153, and the like.

The display unit 151 displays the information processed by the mobile terminal 100. For example, the display unit 151 displays a User Interface (UI) or a Graphic User Interface (GUI) related to communication if the mobile terminal 100 is in the communication mode. In addition, the display unit 151 displays a photographed or received image, or a UI or GUI if the mobile terminal 100 is in the video communication mode or the photographing mode.

As described above, if the display unit 151 and the touchpad construct an inter-layer structure to be configured as a touch screen, the display unit 151 also can be used as an input apparatus, as well as an output apparatus. The display unit 151 may include at least one of a liquid crystal display, a thin film transistor liquid crystal display, an organic light emitting diode, a flexible display, and a three-dimensional display. In addition, two or more display units 151 may be provided depending on the implementation form of the mobile terminal 100.

The audio output module 152 outputs audio data received from the wireless communication unit 110 or stored in the memory 160 in a call signal receiving mode, a communication mode, a recording mode, a voice recognition mode, a broadcasting receive mode, or the like. In addition, the audio output module 152 outputs audio signals related to a function performed in the mobile terminal 100. The audio output module 152 may include a speaker, a buzzer, and the like.

The alarm unit 153 outputs a signal for informing an event generated by the mobile terminal 100. Examples of the event generated by the mobile terminal 100 include a signal reception, a message reception, a key signal input, and the like. The alarm unit 153 may output a signal for informing generation of an event in a form other than an audio signal or a video signal. For example, the alarm unit 153 may output a signal in the form of vibration.

The memory 160 may store a program for performing the process and control of the control unit 180 and perform a function of temporarily storing input and output data.

The control unit controls overall operation of the mobile terminal 100. For example, the control unit 180 performs controls and processes related to a voice communication, a data communication, or a video communication. The control unit 180 can be provided with a multimedia module 181 for playing back multimedia data. The multimedia module 181 can be implemented within the control unit 180 or can be implemented to be separate from the control unit 180.

The power supply unit 190 is supplied with external and internal power under the control of the control unit 180 and supplies power needed for operating each constitutional component.

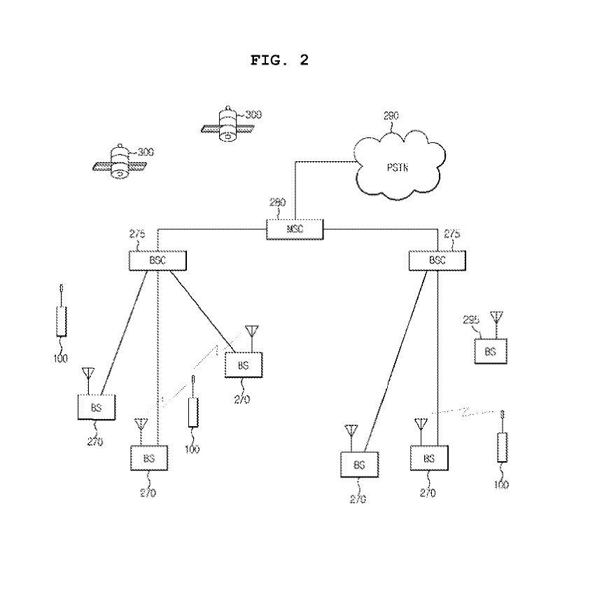

Hereinafter, a communication system in which a mobile terminal 100 related to the present invention may operate will be described with reference to FIG. 2.

A communication system according to one aspect of the present invention may use different wireless interfaces and/or physical layers. For example, a wireless interface that can be used by the communication system may include a frequency division multiple access, a time division multiple access, a code division multiple access, a universal mobile telecommunications system, and a global system for mobile communications. Hereinafter, a CDMA wireless communication system will be described as an example for the convenience of explanation. However, it is apparent that the present invention can be applied to all kinds of communication systems including the CDMA wireless communication system.

The CDMA wireless communication system may include a plurality of terminals 100, a plurality of base stations (BSs) 270, a plurality of base station controllers (BSCs) 275, and a mobile switching center (MSC) 280. The MSC 280 is configured to be connected to a Public Switched Telephone Network (PSTN) 290 and the BSCs 275. The BSCs 275 can be connected to the BSs 270 in pairs through a backhaul line. The backhaul line can be provided depending on at least one of E1/T1, ATM, IP, PPP, Frame Relay, HDSL, ADSL, and xDSL.

The BS 270 may include at least one sector, and each sector may include an omni-directional antenna or an antenna directing a specific radial direction from the BS 270. In addition, each sector may include two or more antennas of a variety of shapes. Each BS 270 may be configured to support allocation of a plurality of frequencies, and each of the plurality of allocated frequencies has a specific spectrum (e.g., 1.25 MHz, 5 MHz, or the like).

An intersection between the sector and the frequency allocation can be referred to as a CDMA channel. The BS 270 can be referred to as a Base Station Transceiver Subsystem (BTS). In this case, a combination of one BSC 275 and at least one BS 270 can be referred to as a term ‘base station’. The base station may represent a “cell site”. A plurality of sectors for a specific BS may be referred to as a plurality of cell sites, respectively.

A broadcasting transmitter (BT) transmits broadcasting signals to the terminals 100 operating within the system. The broadcasting receiver module 111 of FIG. 1 is provided in the terminal 100 in order to receive the broadcasting signals transmitted by the BT 295.

The satellite 300 assists to detect a position of at least one terminal among the plurality of terminals 100. The satellite is provided with a GPS. Although two satellites are shown in FIG. 2, useful position information can be acquired through less than or more than two satellites. The GPS module 115 shown in FIG. 1 cooperates with the satellites 300 in order to acquire desired position information. Here, the position can be traced using all techniques that can trace the position, as well as GPS trace techniques.

The BS 270 receives reverse link signals from a variety of terminals 100. The terminals 100 may be in a state of connecting a call, transmitting and receiving a message, or performing other communication operations. The reverse link signals received by a specific base station 270 are respectively processed within the specific base station 270. Data generated by the process described above is transmitted to a connected BSC 275. The BSC 275 provides a call resource allocation function and a mobility management function, including systemization of soft hand-offs among the base stations 270. In addition, the BSC 275 transmits the received data to the MSC 280 and provides an additional transmission service to connect to a PSTN 290. Similarly, the PSTN 290 is connected to the MSC 280, and the MSC 280 is connected to the BSCs 275. The BSC 275 controls the BSs 270 to transmit forward link signals to the terminals 100.

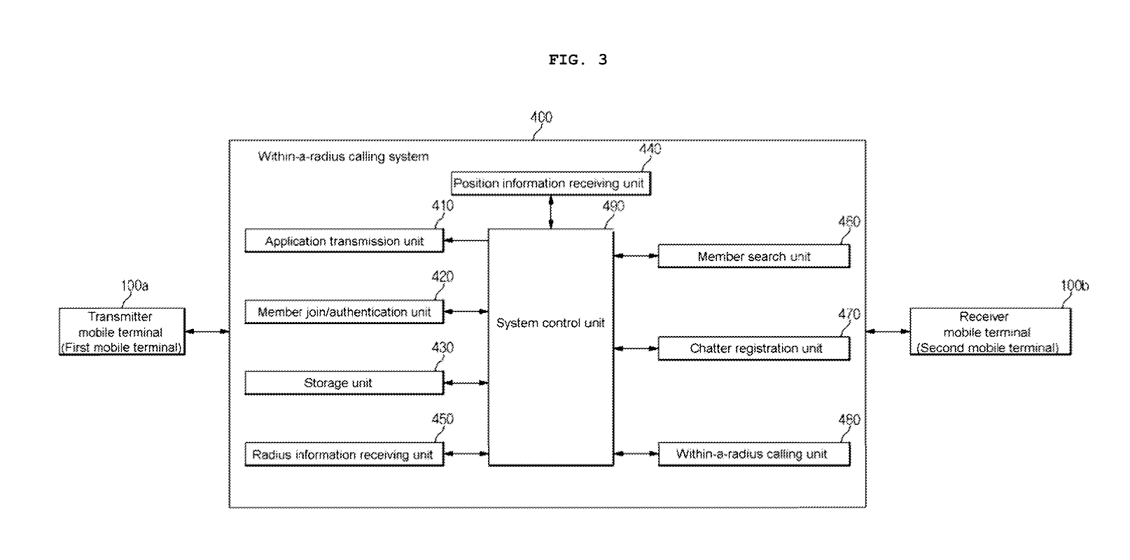

FIG. 3 is a block diagram showing the configuration of a within-a-radius calling system according to an embodiment of the present invention.

The within-a-radius calling system 400 may include an application transmission unit 410, a member join/authentication unit 420, a storage unit 430, a position information receiving unit 440, a radius information receiving unit 450, a member search unit 460, a chatter registration unit 470, a within-a-radius calling unit 480, and a system control unit 490.

The application transmission unit 410 transmits information on an application to the mobile terminal 100. The application information may be an application installation program. The application information may be a Java application. However, the application information is not limited to the Java application, and a variety of program systems can be used. The mobile terminal 100 may install a corresponding application if the application information is received.

The member join/authentication unit 420 performs joining a user using the mobile terminal 100 as a member and authenticating membership of the user. Joining a member is collecting information on the user and joining the user as a member so that the user may use the application. The membership authentication is receiving authentication information transmitted from the user joined as a member and authenticating membership of the user based on the received authentication information so that the user may execute the application.

The storage unit 430 stores membership information of the user joined as a member. The membership information is information including a personal profile such as a name, an address, a picture, height, weight, characters, and the like.

The position information receiving unit 440 receives position information of the mobile terminal 100. The position information module 115 provided in the mobile terminal 100 measures the position information of the mobile terminal 100. The position information module 115 is a module for confirming or obtaining a position of the mobile terminal 100. The position information module 115 may include a GPS module. The GPS module receives position information from three or more satellites. The GPS module may accurately calculate current position from three pieces of position information using trigonometry. Here, the position information may include latitude, longitude, height and three-dimensional speed information.

The radius information receiving unit 450 receives radius setting information of the mobile terminal 100. The radius setting information is radius information manually set by a user. The radius information is information on a radius which is set based on the position of the mobile terminal 100.

The member search unit 460 searches for members based on position information of a transmitter mobile terminal 100a and a receiver mobile terminal 100b and radius information set by the transmitter mobile terminal 100a. The member search unit 460 searches for users, i.e., members, of the receiver mobile terminals 100b positioned within a previously set radius from the position of the transmitter mobile terminal 100a. For example, if the radius setting information of the transmitter mobile terminal 100a is 50 m, the member search unit 460 searches for other members positioned within the radius of 50 m from the transmitter mobile terminal 100a. The user of the transmitter mobile terminal 100a may ask for rescue from the members searched within the radius.

The chatter registration unit 470 may automatically or manually set a member using the transmitter mobile terminal 100 and a member positioned within the previously set radius of the transmitter mobile terminal 100a as friends.

If the user of the transmitter mobile terminal 100a and the user of the receiver mobile terminal 100b positioned within the previously set radius have contact information (a phone number, a mail, or the like) of each other, the chatter registration unit 470 may automatically set the two users as friends.

If only the user of the transmitter mobile terminal 100a among the user of the transmitter mobile terminal 100a and the user of the receiver mobile terminal 100b positioned within the previously set radius has contact information of the counterpart, the chatter registration unit 470 may set the two users as friends only when the user of the transmitter mobile terminal 100a requests to make friends and the counterpart accepts the request.

In addition, the chatter registration unit 470 can be designed such that if only either of the user of the transmitter mobile terminal 100a or the user of the receiver terminal 100b positioned within the previously set radius has contact information of the counterpart, the user having the contact information automatically requests the counterpart to make friends.

Meanwhile, the concept of the transmitter mobile terminal 100a and the receiver mobile terminal 100b is introduced to classify mobile terminals from the viewpoint of a user, and there is no difference between the terms of a transmitter and a receiver among the mobile terminals 100a and 100b. That is, a user currently searching for information on other members by executing an application using the mobile terminal 100 can be regarded as a transmitter, and a searched member is regarded as a receiver. In addition, the transmitter mobile terminal 100 can be expressed as a first mobile terminal, and the receiver mobile terminal 100b can be expressed as a second mobile terminal.

If the user of the transmitter mobile terminal 100a executes an application and transmits a call signal, the within-a-radius calling unit 480 may transmit the call signal to all members positioned within the set radius of the transmitter mobile terminal 100a. The call signal may include an emergency call request signal and a general call request signal.

Although it is not shown in FIG. 3, if an application is executed, a screen capable of requesting a call is displayed on the screen of the transmitter mobile terminal 100a. The screen capable of requesting a call can be provided so as to handle fields of “emergency call request” and “general call request”. If the field “emergency call request” is handled, a signal containing a predetermined message asking for help and position information of the transmitter mobile terminal 100a is transmitted to the within-a-radius calling system 400. For example, the emergency call request signal may be a signal containing a message asking for help saying that “Help me!” and position information of the transmitter mobile terminal 100a. If the field “general call request” is handled, a signal containing a message created by the user of the transmitter mobile terminal 100a and position information of the transmitter mobile terminal 100a is transmitted to the within-a-radius calling system 400. For example, the general call request signal is a signal containing a message saying that “Come to me.” and position information of the transmitter mobile terminal 100a.

If the user of the transmitter mobile terminal 100a handles the interface of the application and transmits a call signal, the within-a-radius calling unit 480 transmits position information of the transmitter mobile terminal 100a to the members positioned within the radius in real-time. Accordingly, although the user of the transmitter mobile terminal 100a moves, the position of the transmitter mobile terminal 100a is traced in real-time. In addition, even when the user of the receiver mobile terminal 100b goes out of the call radius, the transmitter mobile terminal 100a may continuously receive the call signal depending on settings. Of course, it is possible to set the transmitter mobile terminal 100a to stop receiving the call signal if the user of the receiver mobile terminal 100b goes out of the call radius.

If the user of the transmitter mobile terminal 100a executes an application and requests a call, the within-a-radius calling unit 480 may transmit a call request signal to all the members positioned within the set radius of the transmitter mobile terminal 100a.

If the user of the transmitter mobile terminal 100a executes an application and requests a call, the within-a-radius calling unit 480 may transmit a call request signal only to the members registered as a friend among the members positioned within the set radius of the transmitter mobile terminal 100a.

If the user of the transmitter mobile terminal 100a executes an application and requests a call, the within-a-radius calling unit 480 may transmit a call request signal only to the members previously specified among the members positioned within the set radius of the transmitter mobile terminal 100a.

The members from which the call is requested by the within-a-radius calling unit 480 can be uniquely selected among all members positioned within the radius, members registered as a friend among the members positioned within the radius, and members previously specified among the members positioned within the radius, depending on an option previously set by the user of the transmitter mobile terminal 100a.

The system control unit 490 manages overall control of the within-a-radius calling system 400. The system control unit 490 controls the application transmission unit 410 to transmit information on the application if the mobile terminal 100 requests the application information, controls the member join/authentication unit 420 to proceed its procedure if joining or authentication of a member is requested, controls the member search unit 460 to search for other members positioned within a corresponding radius based on radius setting information if the radius setting information is received from the mobile terminal 100, controls the chatter registration unit 470 to make members friends who can used the function of the application according to a request for making friends, and controls the within-a-radius calling unit 480 according to a call request of the transmitter mobile terminal 100a to transmit a call request signal to the members positioned within the radius.

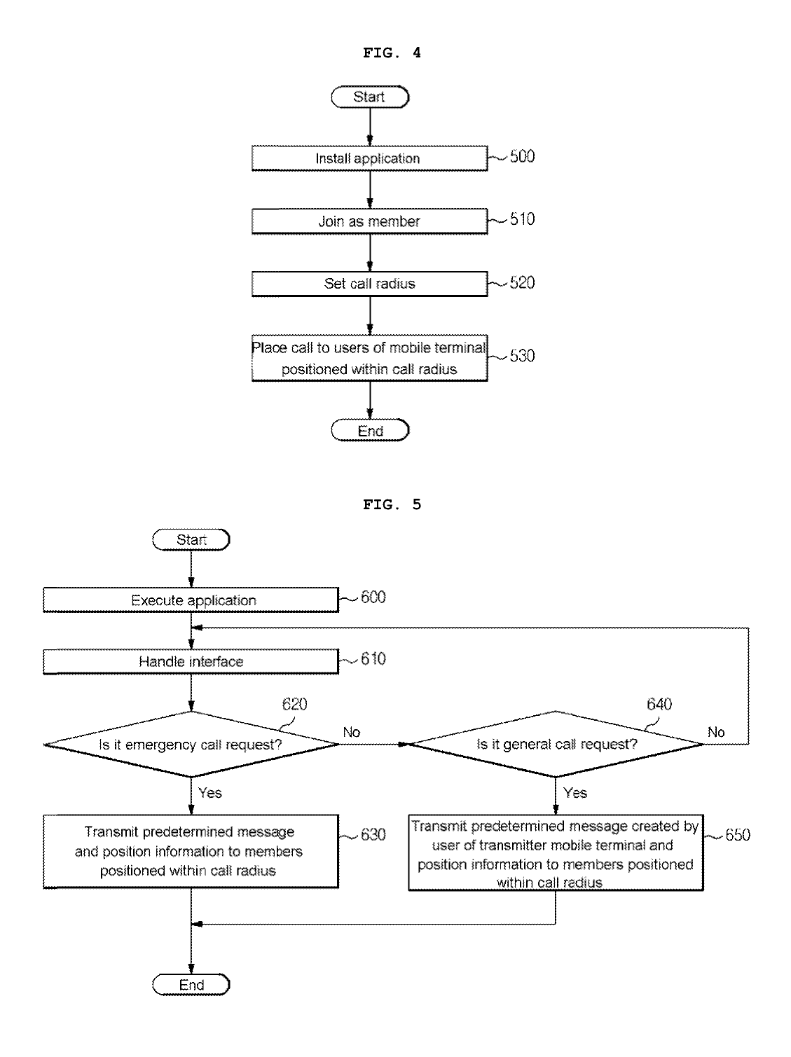

FIG. 4 is a flowchart illustrating the procedure of joining a member and setting a function of a within-a-radius calling system according to an embodiment of the present invention.

The user of the mobile terminal 100 may download an application from the within-a-radius calling system 400 and install the application. (step 500) The application may display members positioned within a certain radius from the position of the mobile terminal 100 and transmit a call request signal to the members positioned within the radius.

After executing the application, the user of the mobile terminal 100 joins as a member of the within-a-radius calling system 400 according to a procedure of joining a member. (step 510)

The user of the mobile terminal 100 may set a call radius by executing the application after joining as a member. The user of the transmitter mobile terminal 100a may transmit a call signal to the displayed members positioned within the radius. The user of the transmitter mobile terminal 100a may specify members who will receive the call signal. For example, any one of all members positioned within the radius, members registered as a friend among the members positioned within the radius, members randomly specified among the members positioned within the radius can be specified as the members who will receive the call signal. (steps 520 and 530)

FIG. 5 is a flowchart illustrating the control flow of a within-a-radius calling system according to an embodiment of the present invention.

If the user of the transmitter mobile terminal 100a executes an application, a screen related to a call request is displayed on the transmitter mobile terminal 100a. The screen related to the call request may be a screen capable of handling “emergency call request” and “general call request”. (step 600)

If the user of the transmitter mobile terminal 100a handles the interface of the application, it is confirmed whether or not an interface related to “emergency call request” is handled. If it is confirmed that the interface related to “emergency call request” is handled, a predetermined message and position information are transmitted to the members positioned within the call radius. The predetermined message may be a message asking for help such as “Help me!”. (steps 610, 620, and 630)

On the other hand, if it is confirmed that the user of the transmitter mobile terminal 100a handles an interface related to “general call request”, a message created by the user of the transmitter mobile terminal 100a and position information of the transmitter mobile terminal 100a are transmitted to the members positioned within the call radius. (steps 640 and 650)

On the other hand, the members receiving the call information may be all members positioned within the radius, members registered as a friend among the members positioned within the radius, and members specified among the members positioned within the radius. The members specified among the members positioned within the radius may be members previously specified before the call request or members specified when the call is requested.

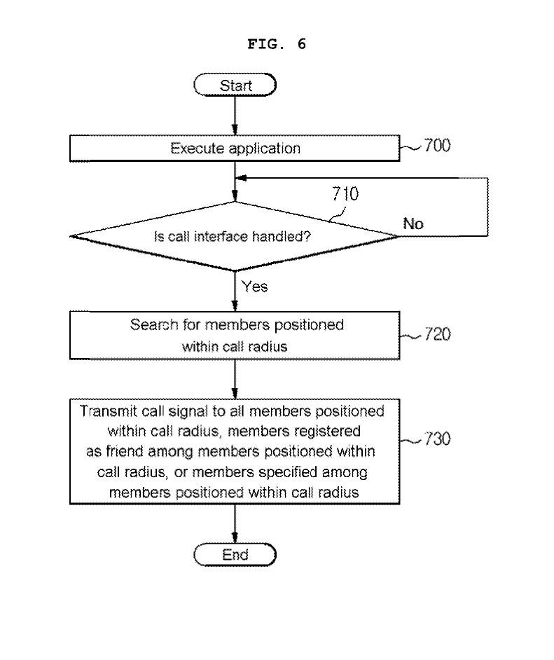

FIG. 6 is a flowchart illustrating the control flow of a within-a-radius calling system according to an embodiment of the present invention.

If the user of the transmitter mobile terminal 100a executes an application, a screen related to a call request is displayed on the transmitter mobile terminal 100a. (step 700)

If a call interface is handled through an application execution screen, the member search unit 460 searches for members positioned within a call radius. The radius is individually determined by the user. For example, the radius may be 50 m, 100 m, 200 m, 1,000 m, or the like. (steps 710 and 720)

Next, the transmitter mobile terminal 100a displays information on the members positioned within the radius searched by the member search unit 460 on an application screen window. The member information may be a profile of a member including height, weight and the like. The user of the transmitter mobile terminal 100a may request an emergency call or a general call from the displayed members positioned within the radius. The user of the transmitter mobile terminal 100a may request a call from all the members positioned within the radius, from the members registered as a friend among the members positioned within the radius, or from the members specified among the members positioned within the radius. When the call is requested, a message and position information of the user of the transmitter mobile terminal 100a are transmitted. The message may be a previously set message or a message created when the call is requested. (step 730)

As described above in detail, according to one aspect of the present invention, a call can be requested from a mobile terminal joined the within-a-radius calling system, in which the mobile terminal is positioned within a certain radius of the mobile terminal joined the within-a-radius calling system.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1-12. (canceled)

13. A within-a-radius calling system comprising:
an application transmission unit for transmitting information on an application so that the application can be installed in a plurality of mobile terminals including a transmitter mobile terminal and a receiver mobile terminal;
a member join/authentication unit for joining a user of the mobile terminal installed with the application as a member and authenticating membership of the user;
a storage unit for storing membership information of the user joined as a member;
a radius information receiving unit for receiving information on a call radius of the transmitter mobile terminal, if the call radius information is set by a user of the transmitter mobile terminal;
a position information receiving unit for receiving position information of the mobile terminal of the user joined as a member;
a member search unit for determining whether or not a receiver mobile terminal used by a member who is not previously specified is positioned within a call radius of the transmitter mobile terminal based on the call radius information; and
a within-a-radius calling unit for transmitting a call signal to receiver mobile terminals of all members or unspecified many of the members positioned within the call radius, if the user of the transmitter mobile terminal requests a call, wherein
the member search unit searches for the receiver mobile terminals positioned within the call radius and updates information thereon in real-time, and the within-a-radius calling unit transmits the call signal to the receiver mobile terminals which are targets varying in real-time depending on a distance to the transmitter mobile terminal and the call radius information.

14. The system according to claim 13, wherein the application displays an interface screen capable of processing the call request on the mobile terminal, and the interface screen is provided so as to handle a field related to an emergency call request and a field related to a general call request.

15. The system according to claim 14, wherein if the user of the transmitter mobile terminal clicks the field related to the emergency call request by handling the interface screen, the within-a-radius calling unit transmits a signal containing a predetermined message and position information of the transmitter mobile terminal to the receiver mobile terminals positioned within the call radius.

16. The system according to claim 14, wherein if the user of the transmitter mobile terminal clicks the field related to the general call request by handling the interface screen, the within-a-radius calling unit transmits a signal containing a message created by the user of the transmitter mobile terminal and position information of the transmitter mobile terminal to the receiver mobile terminals positioned within the call radius.

17. The system according to claim 13, wherein the within-a-radius calling unit transmits a signal containing a message and position information of the transmitter mobile terminal when the within-a-radius calling unit transmits the call signal to the receiver mobile terminals, and the position information of the transmitter mobile terminal is updated and transmitted in real-time.

18. The system according to claim 13, wherein the call radius information received by the radius information receiving unit is information that can be changed by the user of the transmitter mobile terminal.

19. A within-a-radius calling service method for providing a calling service in an environment of connecting a plurality of mobile terminals for providing the calling service and a within-a-radius calling system for relaying a call to enable the calling service among the mobile terminals, the method comprising the steps of:
receiving and installing an application, by the plurality of mobile terminals;
performing a process of joining users of the plurality of mobile terminals as a member and authenticating membership of the users;
receiving information on call radiuses set by the users of the plurality of mobile terminals, by the within-a-radius calling system;
confirming whether or not second mobile terminals used by all members or unspecified many of the members are positioned within a call radius of a first mobile terminal, if a user of the first mobile terminal among the plurality of mobile terminals executes the application in the within-a-radius calling system;
searching for the second mobile terminals positioned within the call radius and updating information thereon in real-time; and
requesting a call from the second mobile terminals which are targets varying in real-time depending on a distance to the first mobile terminal and the call radius information, if the user of the first mobile terminal requests the call in the within-a-radius calling system.

20. The method according to claim 19, further comprising the step of displaying an interface screen capable of processing the call request on the mobile terminal according to handling of the application, wherein the interface screen is provided so as to handle a field related to an emergency call request and a field related to a general call request.

21. The method according to claim 20, wherein in the step of requesting a call from users of the second mobile terminals positioned within the call radius of the first mobile terminal according to a call request of the user of the first mobile terminal in the within-a-radius calling system, if the user of the first mobile terminal clicks the field related to the emergency call request by handling the interface screen, a signal containing a predetermined message and position information of the first mobile terminal is transmitted to the second mobile terminals positioned within the call radius.

22. The method according to claim 20, wherein in the step of requesting a call from users of the second mobile terminals positioned within the call radius of the first mobile terminal according to a call request of the user of the first mobile terminal in the within-a-radius calling system, if the user of the first mobile terminal clicks the field related to the general call request by handling the interface screen, a signal containing a message created by the user of the first mobile terminal and position information of the first mobile terminal is transmitted to the second mobile terminals positioned within the call radius.

23. The method according to claim 19, wherein in the step of requesting a call from users of the second mobile terminals positioned within the call radius of the first mobile terminal according to a call request of the user of the first mobile terminal in the within-a-radius calling system, the call is requested by transmitting a message and position information of the first mobile terminal to the users of the second mobile terminals in the within-a radius calling system.

24. The method according to claim 23, wherein the position information of the first mobile terminal transmitted in the within-a radius calling system is updated and transmitted to the second mobile terminals in real-time.
